(19) United States
(12) Patent Application Publication
(10) Pub. No.: US 2025/0212013 A1
(43) Pub. Date: Jun. 26, 2025

(54) METHODS AND APPARATUS FOR IMPROVED CELL PLACEMENT

(71) Applicant: Intel Corporation, Santa Clara, CA (US)

(72) Inventors: Siddhartha Nath, Danville, CA (US); Mitesh Kumar, San Jose, CA (US); Rajeshkumar S. Sambandam, Folsom, CA (US); Chiradeep Krishnakumar, Portland, OR (US); Avinash Kumar Tiwari, San Jose, CA (US); Sreedhara Khayadada, Folsom, CA (US)

(21) Appl. No.: 18/394,905

(22) Filed: Dec. 22, 2023

(51) Int. Cl. H04W 16/18; H04W 16/24

(52) U.S. Cl. CPC H04W 16/18; H04W 16/24

(57) ABSTRACT

Systems, apparatus, articles of manufacture, and methods are disclosed to improve cell placement in semiconductor dies. An apparatus includes interface circuitry, machine readable instructions, and programmable circuitry to at least one of instantiate or execute the machine readable instructions to extract a gate-level netlist from a cell placement arrangement, the cell placement arrangement corresponding to cells on a semiconductor die, extract information from the gate-level netlist corresponding to an operation of the gate-level netlist, use unsupervised learning to learn an embedding for a node in the gate-level netlist, and update the cell placement arrangement based on the learned embedding of the node.

### FIELD OF THE DISCLOSURE

This disclosure relates generally to electronic design automation (EDA) and, more particularly, to methods and apparatus for improved cell placement.

### BACKGROUND

Electronic design automation (EDA) designs and manufactures semiconductor devices such as processors or integrated circuits (ICs). EDA tools are used to automate or speed up the design and validation of semiconductor manufacturing processes to ensure the semiconductor device (e.g., an electronic chip such as a processor, IC, etc.) delivers required performance and density.

### BRIEF DESCRIPTION OF THE DRAWINGS

FIG. 1 is a block diagram of an example environment in which an example cell analysis circuitry operates to analyze and improve cell placement on a semiconductor die.

FIG. 2 is a block diagram of an example implementation of the example cell analysis circuitry of FIG. 1.

FIGS. 3-5 are flowcharts representative of example machine readable instructions and/or example operations that may be executed, instantiated, and/or performed by example programmable circuitry to implement the cell analysis circuitry of FIG. 2.

FIG. 6 illustrates an example gate-level netlist.

FIG. 7 illustrates an example transposed hypergraph representation of the gate-level netlist of FIG. 6.

FIG. 8 is an example representation of a process to learn and project instance embeddings of a node corresponding to the example gate-level netlist of FIG. 6.

FIG. 9 is an example block diagram corresponding to code to implement the example cell analysis circuitry of FIG. 1.

FIG. 10 is a block diagram of an example processing platform including programmable circuitry structured to execute, instantiate, and/or perform the example machine readable instructions and/or perform the example operations of FIGS. 3-5 to implement the cell analysis circuitry of FIG. 2.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine readable instructions of FIGS. 3-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Electronic design automation (EDA) tools typically place a cell (e.g., a transistor and/or interconnect structure to provide Boolean logic) based on power, performance, and area (PPA) requirements.

The placement step in a digital implementation flow is important for PPA thresholds to be achieved at the end of the flow. Global placers in commercial EDA tools still suffer from a lack of guidance of the global placers to achieve better PPA. Specifically, global placement of cells can be tailored towards performance or power/area by providing soft placement constraints to the tool.

Currently, PPA cell placement either utilizes expert user inputs to create relative placement constraints that often tradeoff performance for power/area, or they have never been shown to work on large-scale designs in modern technology nodes.

Examples disclosed herein may be used to implement an automated approach to guiding cell clusters at a time of placement for better PPA using a neural network/machine learning model. The machine learning framework is transferable to other blocks or different implementations of the same block.

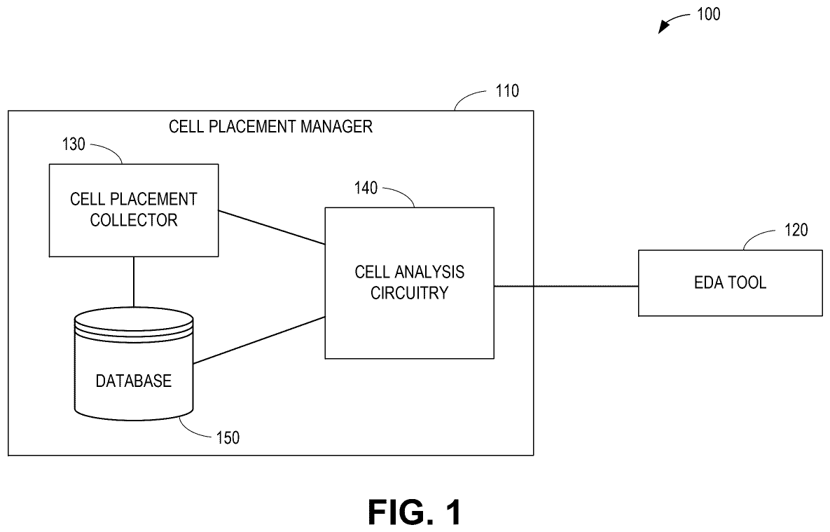

FIG. 1 is a block diagram of an example environment 100 in which an example cell analysis circuitry operates to analyze and improve cell placement on a semiconductor die.

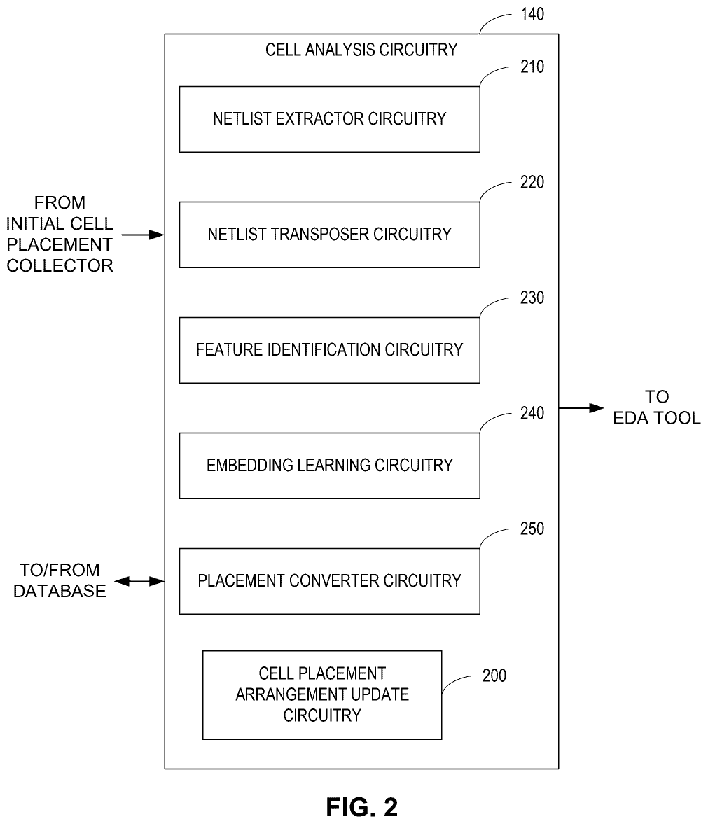

The example environment 100 includes a cell placement manager 110 and an Electronic Design Automation (EDA) tool 120. The cell placement manager 110 manages a cell placement arrangement and provides recommendations (e.g., soft placement guides) to the EDA tool 120 to adjust the cell placement arrangement. In examples disclosed herein, a cell placement arrangement corresponds to a layout of cells on a semiconductor die. In examples disclosed herein, the cell placement manager 110 analyzes the cell placement arrangement to determine whether the cell placement arrangement can be improved (e.g., improve power, performance, and area (PPA)). The cell placement manager 110 may be instantiated (e.g., creating an instance of, bring into being for any length of time, materialize, implement, etc.) by programmable circuitry such as a Central Processor Unit (CPU) executing first instructions. Additionally or alternatively, the cell placement manager 110 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions.

The EDA tool 120 performs an analysis on the cell placement arrangement in light of the recommendations/soft placement guides provided by the cell placement manager 110. The EDA tool 120 rearranges/changes physical placements of cells within the semiconductor die.

The cell placement manager 110 includes a cell placement collector 130, cell analysis circuitry 140, and a database 150.

The cell placement collector 130 retrieves the cell placement arrangement. In some examples, the cell placement arrangement is external to the environment 100 and thus needs to be retrieved/collected from an external source (e.g., an external storage device, structure, or program). In some examples, the cell placement arrangement is stored in the database 150. In such an example, the cell placement collector 130 retrieves the cell placement arrangement from the database 150.

The cell analysis circuitry 140 analyzes the cell placement arrangement collected by the cell placement collector 130. In some examples, the analysis of the cell placement arrangement includes determining whether the cell placement arrangement can be modified to increase performance, decrease power consumption, and/or decrease area requirements on the semiconductor die (e.g., move cells closer together). The cell analysis circuitry 140 provides the recommendations to the EDA tool 120 to modify the cell placement arrangement.

The database 150 stores the cell placement arrangement(s) retrieved by the cell placement collector 130. In some examples, the database 150 is a storage drive (e.g., e.g., a floppy disk, a Hard Disk Drive (HDD), etc.). In other examples, the database 150 is a virtual database accessing storage from an external device such as a server or cloud storage device. In some examples, the cell placement collector 130 and the cell analysis circuitry 140 communicate with the database 150 to send and receive information.

FIG. 2 is a block diagram of an example implementation of the cell analysis circuitry 140 of FIG. 1 to analyze and improve cell placement on a semiconductor die. The cell analysis circuitry 140 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the cell analysis circuitry 140 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example cell analysis circuitry 140 of FIG. 2 includes cell placement arrangement update circuitry 200, netlist extractor circuitry 210, netlist transposer circuitry 220, feature identification circuitry 230, embedding learning circuitry 240, and placement converter circuitry 250.

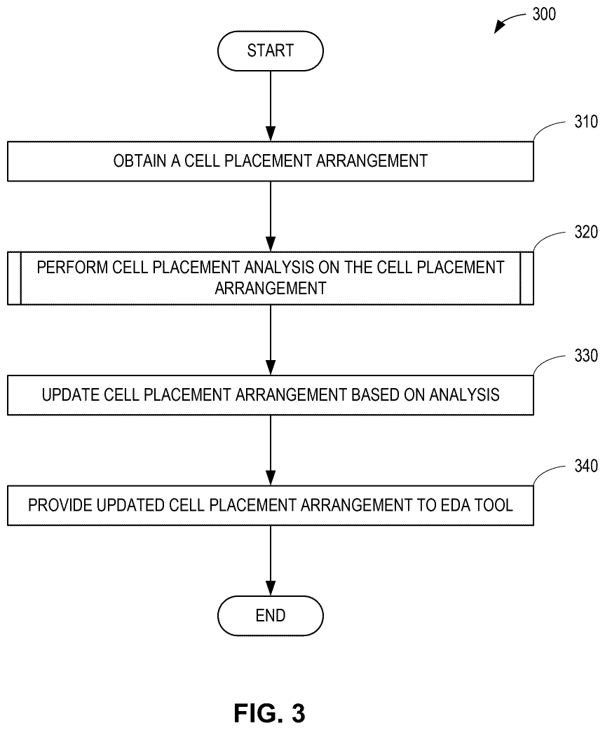

The cell placement arrangement update circuitry 200 updates the cell placement arrangement based on the analysis of the cell placement arrangement. In some examples, the cell placement arrangement update circuitry 200 provides a recommendation to the EDA tool 120 to modify the cell placement arrangement. In some examples, the cell placement arrangement update circuitry 200 is instantiated by programmable circuitry executing cell placement arrangement update instructions and/or configured to perform operations such as those represented by the flowchart of FIG. 3.

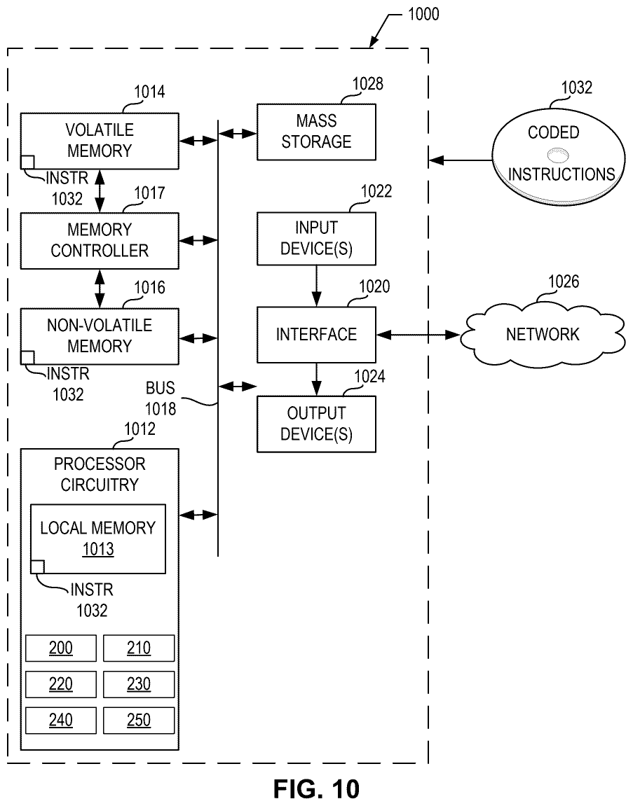

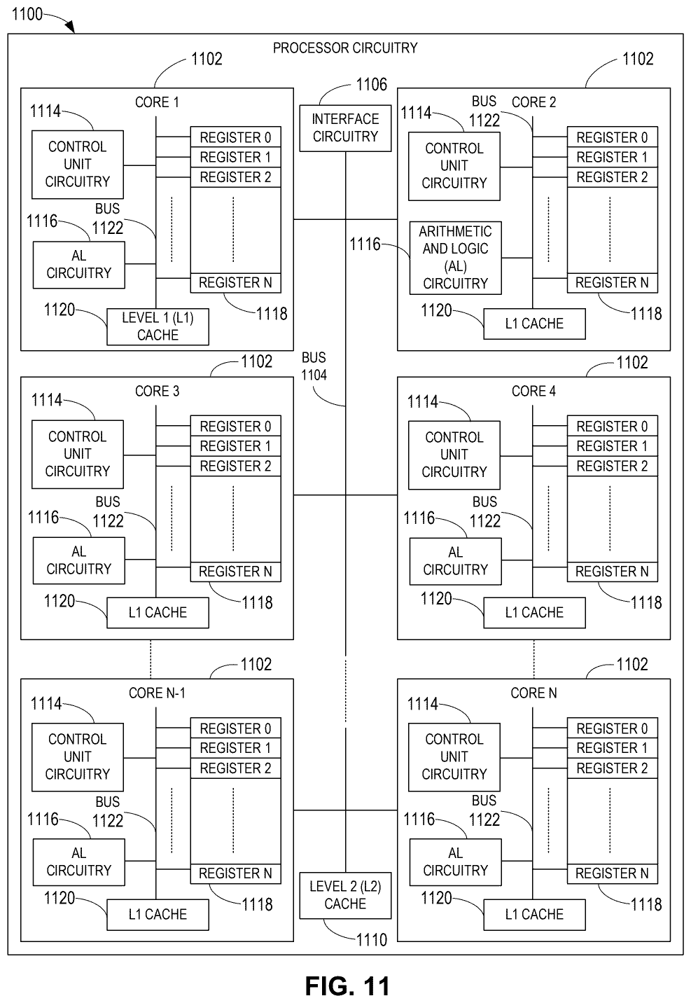

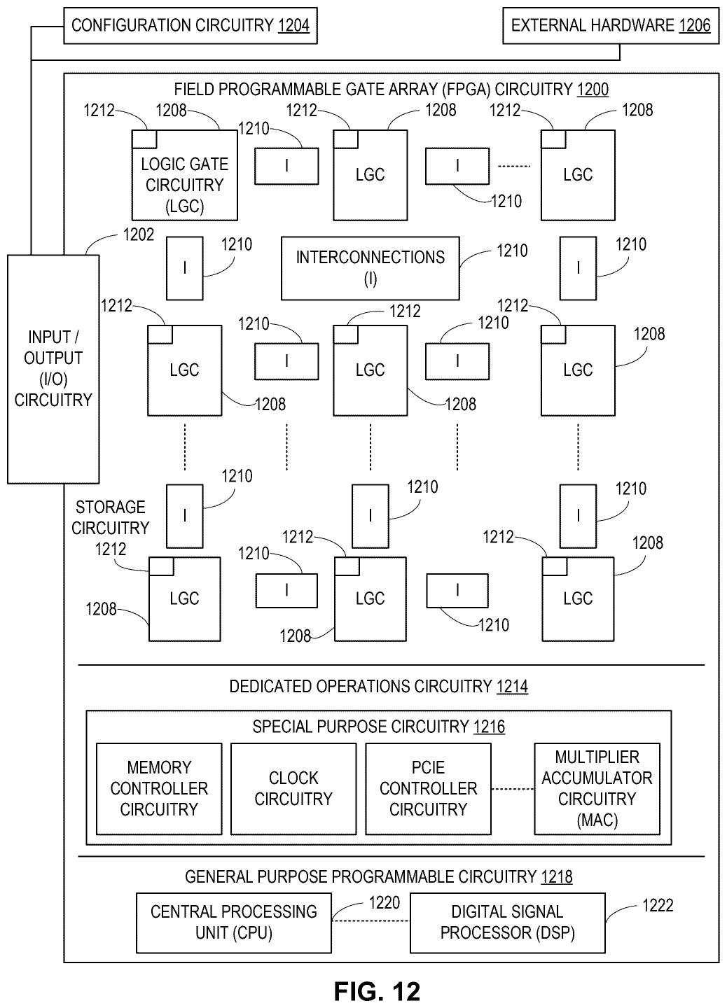

In some examples, the cell analysis circuitry 140 includes means for updating the cell placement arrangement. For example, the means for updating may be implemented by cell placement arrangement update circuitry 200. In some examples, the cell placement arrangement update circuitry 200 may be instantiated by programmable circuitry such as the example programmable circuitry 1012 of FIG. 10. For instance, the cell placement arrangement update circuitry 200 may be instantiated by the example microprocessor 1100 of FIG. 11 executing machine executable instructions such as those implemented by at least block 330 of FIG. 3. In some examples, cell placement arrangement update circuitry 200 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the cell placement arrangement update circuitry 200 may be instantiated by any other combination of hardware, software, and/or firmware. For example, the cell placement arrangement update circuitry 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

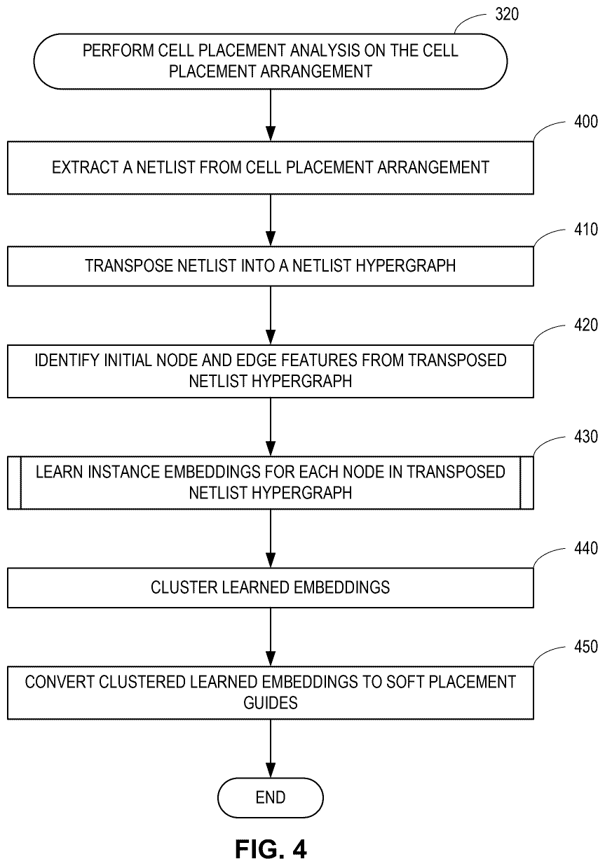

The netlist extractor circuitry 210 extracts a netlist from the cell placement arrangement. In some examples, the netlist extractor circuitry 210 is instantiated by programmable circuitry executing netlist extractor instructions and/or configured to perform operations such as those represented by the flowchart of FIG. 4.

In some examples, the cell analysis circuitry 140 includes means for extracting a gate-level netlist from a cell placement arrangement. For example, the means for extracting may be implemented by netlist extractor circuitry 210. In some examples, the netlist extractor circuitry 210 may be instantiated by programmable circuitry such as the example programmable circuitry 1012 of FIG. 10. For instance, the netlist extractor circuitry 210 may be instantiated by the example microprocessor 1100 of FIG. 11 executing machine executable instructions such as those implemented by at least block 400 of FIG. 4. In some examples, netlist extractor circuitry 210 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the netlist extractor circuitry 210 may be instantiated by any other combination of hardware, software, and/or firmware. For example, the netlist extractor circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The netlist transposer circuitry 220 transposes the gate-level netlist into a netlist hypergraph. In examples disclosed herein, the netlist hypergraph is a graphical representation of nodes and edges in the gate-level netlist. To transpose the gate-level netlist into the netlist hypergraph, each node in the gate-level netlist is identified (e.g., each Boolean logic operator). The identified nodes are then extrapolated to reflect a relationship to surrounding nodes (e.g., each node is connected to neighboring nodes via an edge). These nodes and edges are then used to identify ways to improve the placement of the cells in the cell placement arrangement according to the teaching disclosed herein. In some examples, the netlist transposer circuitry 220 is instantiated by programmable circuitry executing netlist transposer instructions and/or configured to perform operations such as those represented by the flowchart of FIG. 4.

In some examples, the cell analysis circuitry 140 includes means for transposing the gate-level netlist into a hypergraph. For example, the means for transposing may be implemented by netlist transposer circuitry 220. In some examples, the netlist transposer circuitry 220 may be instantiated by programmable circuitry such as the example programmable circuitry 1012 of FIG. 10. For instance, the netlist transposer circuitry 220 may be instantiated by the example microprocessor 1100 of FIG. 11 executing machine executable instructions such as those implemented by at least block 410 of FIG. 4. In some examples, netlist transposer circuitry 220 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the netlist transposer circuitry 220 may be instantiated by any other combination of hardware, software, and/or firmware. For example, the netlist transposer circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The feature identification circuitry 230 identifies initial node and edge features corresponding to the netlist hypergraph. In some examples, the initial node and edge features correspond to power, performance, and area (PPA) requirements. In some examples, the feature identification circuitry 230 is instantiated by programmable circuitry executing feature identification instructions and/or configured to perform operations such as those represented by the flowchart of FIG. 4.

In some examples, the cell analysis circuitry 140 includes means for identifying information from a gate-level netlist. For example, the means for identifying may be implemented by feature identification circuitry 230. In some examples, the feature identification circuitry 230 may be instantiated by programmable circuitry such as the example programmable circuitry 1012 of FIG. 10. For instance, the feature identification circuitry 230 may be instantiated by the example microprocessor 1100 of FIG. 11 executing machine executable instructions such as those implemented by at least block 420 of FIG. 4. In some examples, feature identification circuitry 230 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the feature identification circuitry 230 may be instantiated by any other combination of hardware, software, and/or firmware. For example, the feature identification circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The embedding learning circuitry 240 learns embeddings for node in the gate-level netlist. As used herein, an embedding is a mapping of a discrete, categorical variable to a vector of continuous numbers (e.g., non-finite). Utilizing embeddings to improve cell placement arrangements can be useful because embeddings reduce the dimensionality of categorical variables and meaningfully represent categories in the transformed space. Therefore, each node can be correlated with neighboring nodes to identify commonalities and determine whether cells can be moved closer together without parsing large amounts of individual data regarding each node. In some examples, a Graph Neural Network (GNN) is used to learn embeddings and project nodes to improve PPA. In some examples, unsupervised learning (e.g., learning without using any labels) is used to train the GNN. An example of unsupervised learning includes logits loss of learned embeddings (or representations).

The embedding learning circuitry 240 encodes hierarchy information using sentence transformers. To distinguish instances in same versus different hierarchies, all the hierarchies are represented (up until the instance's parent) as a sentence. For example, if the hierarchy of instance u₀ is hier₁/hier₂/hier₃/u₀, then the hierarchy is encoded as hier[u₀]=SentenceTransformer (hierSentence), where hierSentence=“hier1 hier2 hier3”. Encoding using sentence transformers allows all hierarchy levels to be uniquely encoded for all instances.

In some examples, the embedding learning circuitry 240 is instantiated by programmable circuitry executing embedding learning instructions and/or configured to perform operations such as those represented by the flowcharts of FIGS. 4 and/or 5.

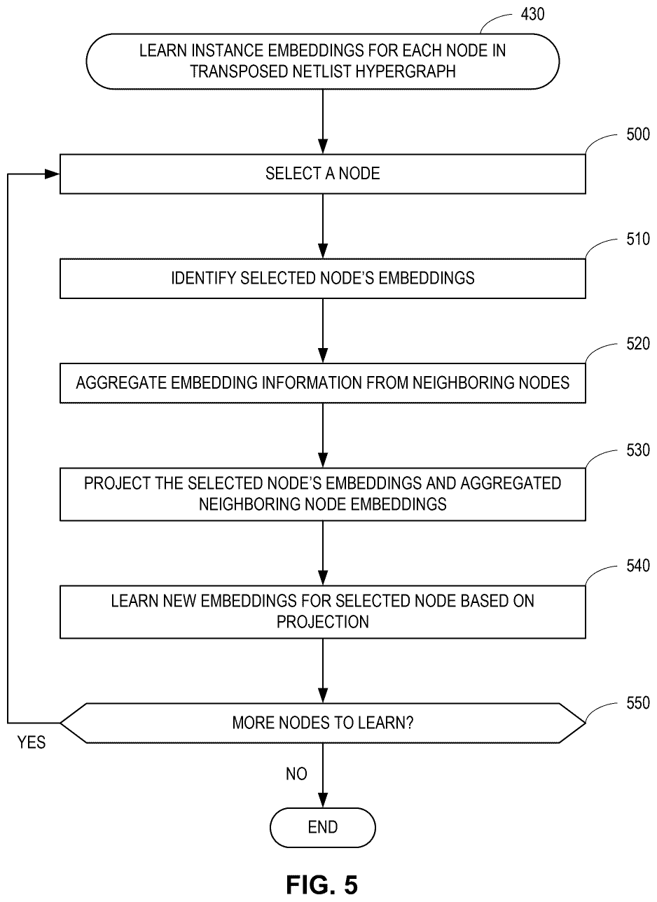

In some examples, the cell analysis circuitry 140 includes means for learning an embedding for a node in the gate-level netlist. For example, the means for learning may be implemented by embedding learning circuitry 240. In some examples, the embedding learning circuitry 240 may be instantiated by programmable circuitry such as the example programmable circuitry 1012 of FIG. 10. For instance, the embedding learning circuitry 240 may be instantiated by the example microprocessor 1100 of FIG. 11 executing machine executable instructions such as those implemented by at least blocks 430 and 440 of FIG. 4 and blocks 500, 510, 520, 530, 540, and 550 of FIG. 5. In some examples, embedding learning circuitry 240 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the embedding learning circuitry 240 may be instantiated by any other combination of hardware, software, and/or firmware. For example, the embedding learning circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The placement converter circuitry 250 converts the clustered embeddings to soft placement guides. In some examples, the placement converter circuitry 250 is instantiated by programmable circuitry executing placement converter instructions and/or configured to perform operations such as those represented by the flowchart of FIG. 4.

In some examples, the cell analysis circuitry 140 includes means for converting the clustered learned embeddings to soft placement guides. For example, the means for converting may be implemented by placement converter circuitry 250. In some examples, the placement converter circuitry 250 may be instantiated by programmable circuitry such as the example programmable circuitry 1012 of FIG. 10. For instance, the placement converter circuitry 250 may be instantiated by the example microprocessor 1100 of FIG. 11 executing machine executable instructions such as those implemented by at least block 450 of FIG. 4. In some examples, placement converter circuitry 250 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the placement converter circuitry 250 may be instantiated by any other combination of hardware, software, and/or firmware. For example, the placement converter circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the cell analysis circuitry 140 of FIG. 1 is illustrated in FIG. 2, one or more of the elements, processes, and/or devices illustrated in FIG. 2 may be combined, divided, re-arranged, omitted, eliminated, and/or implemented in any other way. Further, the example cell placement arrangement update circuitry 200, example netlist extractor circuitry 210, example netlist transposer circuitry 220, example feature identification circuitry 230, example embedding learning circuitry 240, example placement converter circuitry 250 and/or, more generally, the example cell analysis circuitry 140 of FIG. 2, may be implemented by hardware alone or by hardware in combination with software and/or firmware. Thus, for example, any of the example cell placement arrangement update circuitry 200, example netlist extractor circuitry 210, example netlist transposer circuitry 220, example feature identification circuitry 230, example embedding learning circuitry 240, example placement converter circuitry 250, and/or, more generally, the example cell analysis circuitry 140, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example cell analysis circuitry 140 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the cell analysis circuitry 140 of FIG. 2 and/or representative of example operations which may be performed by programmable circuitry to implement and/or instantiate the cell analysis circuitry 140 of FIG. 2, are shown in FIGS. 3-5. The machine readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-5, many other methods of implementing the example cell analysis circuitry 140 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to improve a placement of cells on a semiconductor die. The example machine-readable instructions and/or the example operations 300 of FIG. 3 begin at block 310, at which the cell placement collector 130 obtains a cell placement arrangement. In some examples, the cell placement arrangement is an initial placement of cells on a semiconductor die. In some examples, the cell placement arrangement is an updated cell placement arrangement that has been analyzed and a subsequent analysis is desired.

Once the cell placement collector 130 obtains a cell placement arrangement, the cell analysis circuitry 140 performs a cell placement analysis on the obtained cell placement arrangement. (Block 320). In some examples, performing the cell placement analysis includes identifying nodes (e.g., cells) within the cell placement arrangement and deploying a machine learning model to create an improved cell placement arrangement.

Once the cell analysis circuitry 140 performs the cell placement analysis, the cell placement arrangement update circuitry 200 updates the cell placement arrangement based on the cell placement analysis. (Block 330). In some examples, updating the cell placement arrangement includes replacing the cell placement arrangement with a new cell placement arrangement generated by the cell analysis circuitry 140. In other examples, the cell placement arrangement is supplemented (added, subtracted, etc.) with information provided by the cell analysis circuitry 140 regarding updating the cell placements.

Once the cell placement arrangement update circuitry 200 updates the cell placement arrangement, the updated cell placement arrangement is provided to the EDA tool 120. (Block 340). In some examples, providing the updated cell placement arrangement to the EDA tool 120 allows the EDA tool 120 to perform an additional analysis on the updated cell placement arrangement.

FIG. 4 is a flowchart representative of example machine readable instructions and/or example operations that may be executed, instantiated, and/or performed by programmable circuitry to perform the cell placement analysis on the cell placement arrangement. The example machine-readable instructions and/or the example operations of FIG. 4 begin at block 400, at which the netlist extractor circuitry 210 extracts a gate-level netlist from the cell placement arrangement. In examples disclosed herein, the netlist is a logical representation of operations performed by the cells on semiconductor die (e.g., Boolean operations).

Once the netlist extractor circuitry 210 extracts the gate-level netlist, the netlist transposer circuitry 220 transposes the gate-level netlist into a netlist hypergraph. (Block 410). In some examples, transposing the gate-level netlist into a hypergraph enables the netlist to be analyzed as instances and ports (e.g., analyzing each node based on its interaction and location respective to adjacent nodes) or collectively as nets to allow a Graph Neural Network (GNN) to analyze the netlist.

Once the netlist transposer circuitry 220 transposes the netlist into the netlist hypergraph, the feature identification circuitry 230 identifies initial node and edge features corresponding to the netlist hypergraph. (Block 420). In examples disclosed herein, initial node features include, but are not limited to, node type (e.g., Combo/Seq/Macro/ICG/Port), location, area, input/output transition, bottleneck slack, input/output capacitance, leakage power, etc. In examples disclosed herein, initial edge features include, but are not limited to, net arc delay, pin-to-pin distance, toggle rate, switching power, etc.

Once the initial node and edge features are identified by the feature identification circuitry 230, the embedding learning circuitry 240 learns instance embeddings for each node in the transposed netlist hypergraph. (Block 430). In some examples, learning the instance embeddings includes aggregating and projecting embeddings from neighboring nodes onto a current node being analyzed. In examples disclosed herein, the embedding learning circuitry 240 implements an unsupervised learning (e.g., learning without using any labels) algorithm to train the GNN such as logits loss of learned embeddings. Further details regarding the embedding learning circuitry 240 are discussed herein in reference to FIG. 5.

Once the embedding learning circuitry 240 learns instance embeddings for each node, the embedding learning circuitry 240 clusters the learned embeddings. (Block 440). In some examples, the learned embeddings are clustered based on hierarchy (e.g., instance embeddings are similar or relatively closely related) or PPA characteristics. The embedding learning circuitry 240 implements a clustering algorithm such as k-means, Louvain or Gaussian Mixture Models, etc.

Once the learned embeddings are clustered by the embedding learning circuitry 240, the placement converter circuitry 250 converts the clustered embeddings to soft placement guides for the EDA tool 120. (Block 450). In some examples, soft placement guides are a recommendation for the EDA tool 120 to implement. In some examples, the EDA tool 120 may diverge from the soft placement guides provided by the placement converted circuitry 250 if cell density (e.g., relative distance between cells) is a concern or if a design of a semiconductor device requires the cells to be spread out. In some examples, the placement converter circuitry 250 generates a new cell placement arrangement to replace the previous cell placement arrangement.

FIG. 5 is a flowchart representative of example machine readable instructions and/or example operations that may be executed, instantiated, and/or performed by programmable circuitry to learn instance embeddings for each node in the transposed netlist hypergraph. The example machine-readable instructions and/or the example operations of FIG. 5 begin at block 500, at which the embedding learning circuitry 240 selects a node from a list of nodes identified when the netlist is transposed. In some examples, the list/table/collection of nodes includes all nodes within a semiconductor device. In other examples, the list of nodes includes a select portion of nodes (e.g., a sub-set of the total number of nodes to analyze).

Once the embedding learning circuitry 240 selects a node, the embedding learning circuitry 240 identifies the embeddings of the node selected. (Block 510). In some examples, the embeddings include initial node and edge features such as those discussed in connection with FIG. 4. In other examples, the embeddings include backpropagated node and edge features resulting from previous executions of the embedding learning process disclosed herein.

Once the embedding learning circuitry 240 identifies the node's embeddings, the embedding learning circuitry 240 aggregates embedding information from neighboring nodes. (Block 520). In examples disclosed herein, neighboring embeddings include initial node and edge features such as those discussed in connection with FIG. 4 or backpropagated node and edge features. In some examples, aggregating the neighboring embeddings includes multiplying the neighboring embeddings by a weight matrix, the weight matrix storing neighboring embeddings with a weight assigned to the neighboring embeddings (e.g., an importance/scaling factor). An aggregation function is then applied to the aggregated embeddings multiplied by the weight matrix such as a mean, sum, etc.

Once the embedding learning circuitry 240 aggregates embedding information from neighboring nodes, the embedding learning circuitry 240 projects the identified embeddings from the selected node and the aggregated neighboring node embeddings to obtain a projected node. (Block 530). In some examples, the projecting includes multiplying the embeddings for the selected node with the aggregated neighboring embeddings.

Once the embedding learning circuitry 240 obtains the projected node, the embedding learning circuitry 240 learns new embeddings for the projected node based on the projection. (Block 540). In some examples, an activation function is performed on the projection. The activation function produces the projected node. In some examples, the activation function includes Rectified Linear Unit (ReLU), sigmoid, etc.

Once the embedding learning circuitry 240 learns the new embeddings, the embedding learning circuitry 240 determines whether there are additional nodes to analyze. (Block 550). When the embedding learning circuitry 240 determines that there are more nodes to analyze (e.g., block 550 returns a result of YES), the operations of blocks 500-540 are repeated. When the embedding learning circuitry 240 determines that there are no additional nodes to analyze (e.g., block 550 returns a result of NO), the operations of FIG. 5 end.

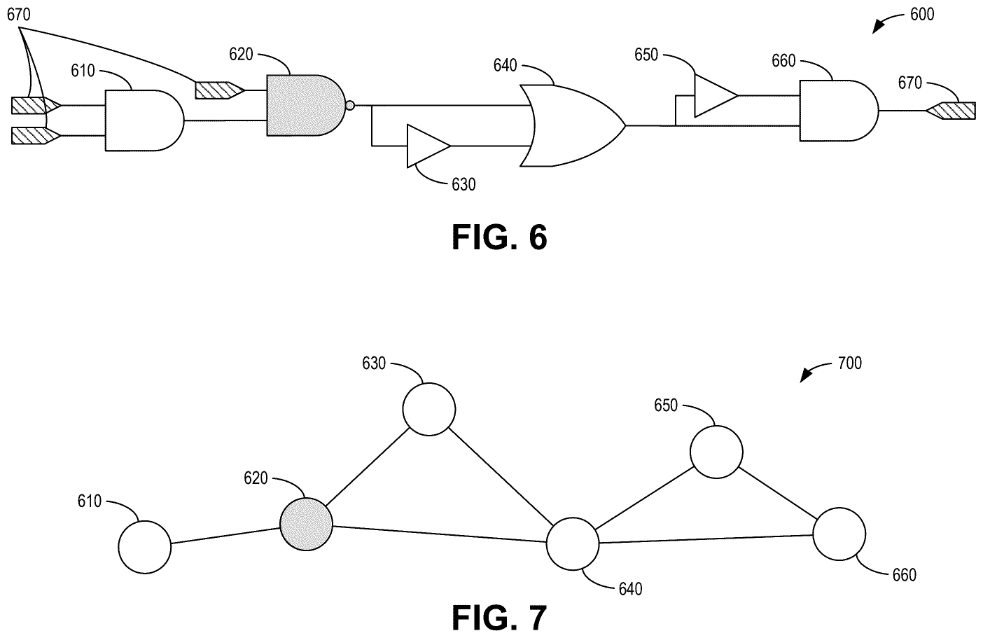

FIG. 6 illustrates an example gate-level netlist 600. The example gate-level netlist 600 represents a selection of operations that can be performed based on a cell placement arrangement. The example selection of FIG. 6 includes six operations/nodes.

In the example of FIG. 6, a first node 610 corresponds to an AND function, a second node 620 corresponds to a NAND function, a third node 630 corresponds to a NOT function, a fourth node 640 corresponds to an OR function, a fifth node 650 corresponds to a NOT function, and a sixth node 660 corresponds to an AND function. As illustrated in FIG. 6, the second node 620 is selected as a node to analyze based on the teachings disclosed herein.

The example of FIG. 6 includes a series of inputs/outputs 670 connected to the first node 610, the second node 620, and the sixth node 660. In some examples, more or less inputs/outputs 670 can be utilized according to the cell placement arrangement.

FIG. 7 illustrates an example transposed hypergraph 700 (referred to hereafter as the hypergraph 700) of the gate-level netlist 600 of FIG. 6. The hypergraph 700 includes nodes corresponding to each node in FIG. 6 (e.g., the first, second, third, fourth, fifth, and sixth nodes 610, 620, 630, 640, 650, 660). Each line connecting the nodes is an edge or a net.

The example of FIG. 7 illustrates node relationships (e.g., connections between neighboring nodes). The second node 620, as highlighted again in FIG. 7, includes three relationships: a first connection with the first node 610, a second connection with the third node 630, and a third connection with the fourth node 640. Likewise, each remaining node will have relationships between neighboring nodes. For example purposes, the second node 620 is highlighted and analyzed herein.

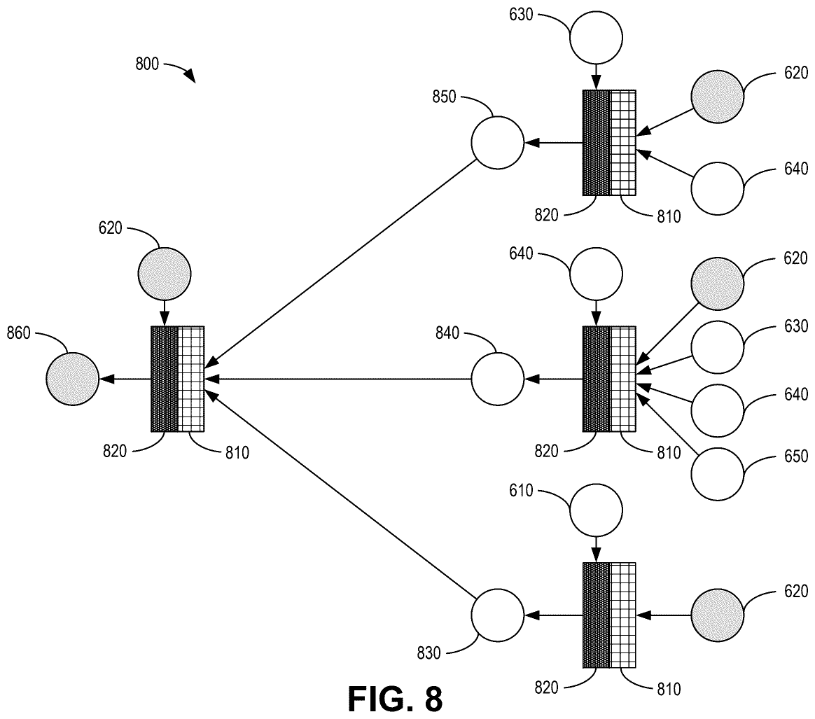

FIG. 8 is an example representation of a process 800 to learn and project instance embeddings of a node (e.g., the second node 620) corresponding to the example gate-level netlist 600 of FIG. 6. In the example of FIG. 8, the first node 610, the third node 630, and the fourth node 640 are aggregated and projected to a new node, which is then aggregated and projected onto the second node 620 to learn the instance embeddings of the second node 620. Each node neighboring the second node 620 is projected using an aggregation of neighboring embeddings to each node and current embeddings of the node being projected. An example process is detailed herein to learn instance embeddings for the second node 620.

Using a GNN, the following inputs are used to configure the GNN to learn the embeddings for the second node 620: (1) a number of neighbors, k=2 or 2-hops (equivalent to 3 neighbors since k=0 equals one neighbor), which is realized using 2 convolution layers, (2) a ReLU activation function, (3) an Adam optimizer, (4) a number of epochs equal to 250, (5) a learning rate from 1e⁻³ to 1e⁻⁵ (adaptive within the range), (6) an embedding dimension equal to 256, (7) a k-means clustering algorithm, and (8) a number of clusters equal to 100. It should be understood that the configuration of the GNN is modifiable based on the inputs provided and the teachings disclosed herein are not limited to the inputs in the example of FIG. 8.

Starting at the bottom right of FIG. 8, neighboring embeddings of the first node 610 are aggregated. Since the second node 620 is the only node that neighbors the first node 610, the current embeddings of the second node 620 are fed into an aggregator 810 to aggregate the neighboring embeddings. In some examples, current embeddings include initial node and edge features such as those discussed in connection with FIG. 4. In other examples, the current embeddings include backpropagated node and edge features resulting from previous executions of the embedding learning process. The aggregator 810 multiplies the neighboring embeddings (e.g., the current embeddings for the second node 620) by a weight matrix and then applies an aggregation function to the result. Examples of aggregation functions include, but are not limited to, mean, sum, etc.

When the neighboring embeddings have been aggregated by the aggregator 810 for neighboring nodes to the first node 610, a projector 820 projects the first node 610 by multiplying the current embeddings for the first node 610 with the aggregated neighboring embeddings. An activation function is then applied to the projection by the projector 820. Examples of activation functions include, but are not limited to, Rectified Linear Unit (ReLU), sigmoid, etc. The result is a first projected node 830 representing a projection of the first node 610.

Moving to the analysis of the fourth node 640, neighboring embeddings from the second node 620, the third node 630, the fourth node 640, and the fifth node 650 are aggregated by the aggregator 810. The resulting aggregation is projected by the projector 820 by multiplying the aggregated neighboring embeddings with the current embeddings for the fourth node 640 and applying an activation function to the output of the multiplication. The result is a second projected node 840 representing a projection of the fourth node 640.

Next, for purposes of the illustration of FIG. 8, for the analysis of the third node 630, neighboring embeddings from the second node 620 and the fourth node 640 are aggregated by the aggregator 810. The resulting aggregation is projected by the projector 820 by multiplying the aggregated neighboring embeddings with the current embeddings for the third node 630 and applying an activation function to the output of the multiplication. The result is a third projected node 850 representing a projection of the third node 630.

The aggregator 810 then performs an aggregation on the first, second, and third projected nodes 830, 840, 850, each representing neighboring nodes to the second node 620. The resulting aggregation is thus projected by the projector 820 with the current embeddings for the second node 620 to obtain a final projected node 860. The final projected node 860 thus represents the learned instance embeddings of the second node 620 based on an analysis of the second node 620 and the neighboring nodes (e.g., the first node 610, the third node 630, and the fourth node 640).

It should be understood that the process detailed with respect to FIG. 8 is not limited to the example provided. Hence, the process for learning instance embeddings disclosed herein can be applied to any number of nodes including any number of neighboring nodes.

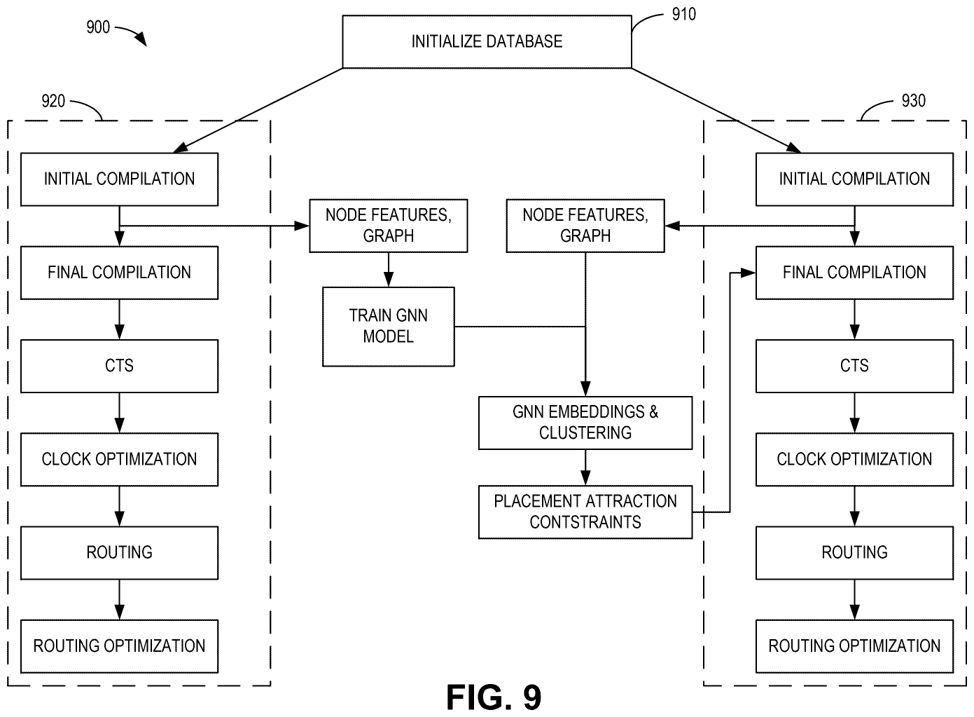

FIG. 9 is an example block diagram 900 corresponding to code to implement the example cell analysis circuitry 140 of FIG. 1. The example execution diagram 900 initializes a database (e.g., block 910) for executing the embedding learning process disclosed herein. In some examples, initializing the database clears cache, initializes Random Access Memory (RAM) for quicker data reads/writes, etc.

A baseline model 920 is used to generate node features and a hypergraph of a baseline netlist. An initial compilation is performed on the baseline model 920 to generate the node features and the hypergraph of the baseline netlist.

The node features and hypergraph are extracted from the baseline model 920. The extracted node features and hypergraph are subsequently fed into a Graph Neural Network (GNN) to train the GNN.

Likewise, an inference model 930 is used to generate inferred node features and an inferred hypergraph. Inferred node features and the inferred hypergraph include predictions on embeddings and PPA requirements. For example, the inferred node features could include predicted node locations, node types, leakage power, etc. and the inferred hypergraph could include a prediction on which nodes would benefit from being adjusted/moved.

An output of the training of the GNN model based on the baseline model 920 and the inferred node features and inferred hypergraph from the inference model 930 are then aggregated and projected to determine instance embeddings and clustering recommendations.

These recommendations are then compared against an existing cell placement arrangement to determine placement attraction constraints. Placement attraction constraints can include overall PPA improvements or any other kind of resulting increases or decreases in performance or any other metric.

These placement constraints are then fed back into the inference model 930 to perform a final compilation based on the projection and placement attraction constraints. In some examples, the final compilation can occur at another point within the inference model 930 (e.g., anytime after the final compilation of the inference model 930). It may be beneficial to compile the inference model 930 at a later time if more information regarding the learning of the instance embeddings becomes known (e.g., subsequent learning routines).

FIG. 10 is a block diagram of an example programmable circuitry platform 1000 structured to execute and/or instantiate the example machine-readable instructions and/or the example operations of FIGS. 3-5 to implement the cell analysis circuitry 140 of FIG. 2. The programmable circuitry platform 1000 can be, for example, a server, a personal computer, a workstation, a self-learning machine (e.g., a neural network), a mobile device (e.g., a cell phone, a smart phone, a tablet such as an iPad™), or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements example cell placement arrangement update circuitry 200, example netlist extractor circuitry 210, example netlist transposer circuitry 220, example feature identification circuitry 230, example embedding learning circuitry 240, and example placement converter circuitry 250.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.). The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 3-5, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 3-5 to effectively instantiate the circuitry of FIG. 2 as logic circuits to perform operations corresponding to those machine readable instructions. In some such examples, the circuitry of FIG. 2 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 3-5.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowchart(s) of FIGS. 3-5 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-5. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-5. As such, the FPGA circuitry 1200 may be configured and/or structured to effectively instantiate some or all of the operations/functions corresponding to the machine readable instructions of the flowchart(s) of FIGS. 3-5 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 3-5 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 3-5 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine readable instructions represented by the flowchart(s) of FIGS. 3-5 to perform first operation(s)/function(s), the FPGA circuitry 1200 of FIG. 12 may be configured and/or structured to perform second operation(s)/function(s) corresponding to a second portion of the machine readable instructions represented by the flowcharts of FIG. 3-5, and/or an ASIC may be configured and/or structured to perform third operation(s)/function(s) corresponding to a third portion of the machine readable instructions represented by the flowcharts of FIGS. 3-5.

It should be understood that some or all of the circuitry of FIG. 2 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 2 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

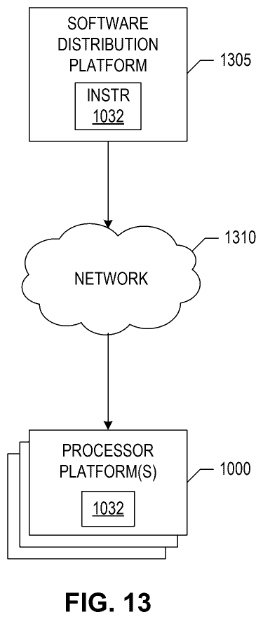

A block diagram illustrating an example software distribution platform 1305 to distribute software such as the example machine readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions of FIGS. 3-5, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions of FIG. 3-5, may be downloaded to the example programmable circuitry platform 1000, which is to execute the machine readable instructions 1032 to implement the cell analysis circuitry 140. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that provide improved cell placement on semiconductor dies. Disclosed systems, apparatus, articles of manufacture, and methods improve the efficiency of using a computing device by using a Graph Neural Network (GNN) to learn embeddings of nodes in a gate-level netlist to provide recommendations to an EDA tool to modify placement of cells on a semiconductor die. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to improve cell placement in semiconductor dies are disclosed herein. Further examples and combinations thereof include the following:
Example 1 includes an apparatus comprising interface circuitry, machine readable instructions, and programmable circuitry to at least one of instantiate or execute the machine readable instructions to extract a gate-level netlist from a cell placement arrangement, the cell placement arrangement corresponding to cells on a semiconductor die, extract information from the gate-level netlist corresponding to an operation of the gate-level netlist, use unsupervised learning to learn an embedding for a node in the gate-level netlist, and update the cell placement arrangement based on the learned embedding of the node.
Example 2 includes the apparatus of example 1, wherein the information corresponding to the operation of the gate-level netlist includes at least one of a power, a performance, and an area.
Example 3 includes the apparatus of example 1, wherein the embedding is a relationship between the node in the gate-level netlist and a neighboring node that interacts with the node.
Example 4 includes the apparatus of example 3, wherein the programmable circuitry is to transpose the gate-level netlist into a hypergraph to identify the node.
Example 5 includes the apparatus of example 4, wherein the programmable circuitry is to identify a plurality of nodes in the hypergraph, and learn embeddings for the plurality of nodes identified.
Example 6 includes the apparatus of example 5, wherein the programmable circuitry is to cluster the learned embeddings.
Example 7 includes the apparatus of example 6, wherein the programmable circuitry is to convert the clustered learned embeddings to soft placement guides, the soft placement guides to be used to update the cell placement arrangement.
Example 8 includes the apparatus of example 3, wherein, to learn the embedding, the programmable circuitry is to identify an existing embedding for the node.
Example 9 includes the apparatus of example 8, wherein the node is a first node and the neighboring node is a second node, wherein the programmable circuitry is to aggregate a neighboring embedding from the second node, the aggregated neighboring embedding including features of the second node corresponding to an operation of the second node, the neighboring embedding to be stored in a weight matrix.
Example 10 includes the apparatus of example 9, wherein the programmable circuitry is to project the existing embedding and the aggregated neighboring embedding to the node using the weight matrix, and learn the embedding for the node based on the projection.
Example 11 includes a non-transitory machine readable storage medium comprising instructions to cause programmable circuitry to at least extract a gate-level netlist from a cell placement arrangement, the cell placement arrangement corresponding to cells on a semiconductor die, extract information from the gate-level netlist corresponding to an operation of the gate-level netlist, use unsupervised learning to learn an embedding for a node in the gate-level netlist, and update the cell placement arrangement based on the learned embedding of the node.
Example 12 includes the non-transitory machine readable storage medium of example 11, wherein the information corresponding to the operation of the gate-level netlist includes at least one of a power, a performance, and an area.
Example 13 includes the non-transitory machine readable storage medium of example 11, wherein the embedding is a relationship between the node in the gate-level netlist and a neighboring node that interacts with the node.
Example 14 includes the non-transitory machine readable storage medium of example 13, wherein the instructions cause the programmable circuitry to transpose the gate-level netlist into a hypergraph to identify the node.
Example 15 includes the non-transitory machine readable storage medium of example 14, wherein the instructions cause the programmable circuitry to identify a plurality of nodes in the hypergraph, and learn embeddings for the plurality of nodes identified.
Example 16 includes the non-transitory machine readable storage medium of example 15, wherein the instructions cause the programmable circuitry to cluster the learned embeddings.
Example 17 includes the non-transitory machine readable storage medium of example 16, wherein the instructions cause the programmable circuitry to convert the clustered learned embeddings to soft placement guides, the soft placement guides to be used to update the cell placement arrangement.
Example 18 includes the non-transitory machine readable storage medium of example 13, wherein, to learn the embedding, the instructions cause the programmable circuitry to identify an existing embedding for the node.
Example 19 includes the non-transitory machine readable storage medium of example 18, wherein the node is a first node and the neighboring node is a second node, wherein the instructions cause the programmable circuitry to aggregate a neighboring embedding from the second node, the aggregated neighboring embedding including features of the second node corresponding to an operation of the second node, the neighboring embedding to be stored in a weight matrix.
Example 20 includes the non-transitory machine readable storage medium of example 19, wherein the instructions cause the programmable circuitry to project the existing embedding and the aggregated neighboring embedding to the node using the weight matrix, and learn the embedding for the node based on the projection.
Example 21 includes a method comprising extracting a gate-level netlist from a cell placement arrangement, the cell placement arrangement corresponding to cells on a semiconductor die, identifying information from the gate-level netlist corresponding to an operation of the gate-level netlist, learning, using unsupervised learning, an embedding for a node in the gate-level netlist, and updating the cell placement arrangement based on the learned embedding of the node.
Example 22 includes the method of example 21, wherein the information corresponding to the operation of the gate-level netlist includes at least one of a power, a performance, and an area.
Example 23 includes the method of example 21, wherein the embedding is a relationship between the node in the gate-level netlist and a neighboring node that interacts with the node.
Example 24 includes the method of example 23, further including transposing the gate-level netlist into a hypergraph to identify the node.
Example 25 includes the method of example 24, further including identifying a plurality of nodes in the hypergraph, and learning embeddings for the plurality of nodes identified.
Example 26 includes the method of example 25, further including clustering the learned embeddings.
Example 27 includes the method of example 26, further including converting the clustered learned embeddings to soft placement guides, the soft placement guides to be used to update the cell placement arrangement.
Example 28 includes the method of example 23, further including identifying an existing embedding for the node.
Example 29 includes the method of example 28, wherein the node is a first node and the neighboring node s a second node, the method further including aggregating a neighboring embedding from the second node, the aggregated neighboring embedding including features of the second node corresponding to an operation of the second node, the neighboring embedding to be stored in a weight matrix.
Example 30 includes the method of example 29, further including projecting the existing embedding and the aggregated neighboring embedding to the node using the weight matrix, and learning the embedding for the node based on the projection.
Example 31 includes an apparatus comprising means for extracting a gate-level netlist from a cell placement arrangement, the cell placement arrangement corresponding to cells on a semiconductor die, means for identifying information from the gate-level netlist corresponding to an operation of the gate-level netlist, means for learning, using unsupervised learning, an embedding for a node in the gate-level netlist, and means for updating the cell placement arrangement based on the learned embedding of the node.
Example 32 includes the apparatus of example 31, wherein the information corresponding to the operation of the gate-level netlist includes at least one of a power, a performance, and an area.
Example 33 includes the apparatus of example 31, wherein the embedding is a relationship between the node in the gate-level netlist and a neighboring node that interacts with the node.
Example 34 includes the apparatus of example 33, further including means for transposing the gate-level netlist into a hypergraph to identify the node.
Example 35 includes the apparatus of example 34, wherein the means for transposing is to identify a plurality of nodes in the hypergraph and the means for learning is to learn embeddings for the plurality of nodes identified.
Example 36 includes the apparatus of example 35, wherein the means for learning is to cluster the learned embeddings.
Example 37 includes the apparatus of example 36, further including means for converting the clustered learned embeddings to soft placement guides, the soft placement guides to be used to update the cell placement arrangement.
Example 38 includes the apparatus of example 33, wherein the means for learning is to identify an existing embedding for the node.
Example 39 includes the apparatus of example 38, wherein the node is a first node and the neighboring node is a second node, wherein the means for learning is to aggregate a neighboring embedding from the second node, the aggregated neighboring embedding including features of the second node corresponding to an operation of the second node, the neighboring embedding to be stored in a weight matrix.
Example 40 includes the apparatus of example 39, wherein the means for learning is to project the existing embedding and the aggregated neighboring embedding to the node using the weight matrix, and learn the embedding for the node based on the projection.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry;
machine readable instructions; and
programmable circuitry to at least one of instantiate or execute the machine readable instructions to:
extract a gate-level netlist from a cell placement arrangement, the cell placement arrangement corresponding to cells on a semiconductor die;
extract information from the gate-level netlist corresponding to an operation of the gate-level netlist;
use unsupervised learning to learn an embedding for a node in the gate-level netlist; and
update the cell placement arrangement based on the learned embedding of the node.

2. The apparatus of claim 1, wherein the information corresponding to the operation of the gate-level netlist includes at least one of a power, a performance, and an area.

3. The apparatus of claim 1, wherein the embedding is a relationship between the node in the gate-level netlist and a neighboring node that interacts with the node.

4. The apparatus of claim 3, wherein the programmable circuitry is to transpose the gate-level netlist into a hypergraph to identify the node.

5. The apparatus of claim 4, wherein the programmable circuitry is to:
identify a plurality of nodes in the hypergraph; and
learn embeddings for the plurality of nodes identified.

6. The apparatus of claim 5, wherein the programmable circuitry is to cluster the learned embeddings.

7. The apparatus of claim 6, wherein the programmable circuitry is to convert the clustered learned embeddings to soft placement guides, the soft placement guides to be used to update the cell placement arrangement.

8. The apparatus of claim 3, wherein, to learn the embedding, the programmable circuitry is to identify an existing embedding for the node.

9. The apparatus of claim 8, wherein the node is a first node and the neighboring node is a second node, wherein the programmable circuitry is to aggregate a neighboring embedding from the second node, the aggregated neighboring embedding including features of the second node corresponding to an operation of the second node, the neighboring embedding to be stored in a weight matrix.

10. The apparatus of claim 9, wherein the programmable circuitry is to:
project the existing embedding and the aggregated neighboring embedding to the node using the weight matrix; and
learn the embedding for the node based on the projection.

11. A non-transitory machine readable storage medium comprising instructions to cause programmable circuitry to at least:
extract a gate-level netlist from a cell placement arrangement, the cell placement arrangement corresponding to cells on a semiconductor die;
extract information from the gate-level netlist corresponding to an operation of the gate-level netlist;
use unsupervised learning to learn an embedding for a node in the gate-level netlist; and
update the cell placement arrangement based on the learned embedding of the node.

12. The non-transitory machine readable storage medium of claim 11, wherein the information corresponding to the operation of the gate-level netlist includes at least one of a power, a performance, and an area.

13. The non-transitory machine readable storage medium of claim 11, wherein the embedding is a relationship between the node in the gate-level netlist and a neighboring node that interacts with the node.

14. The non-transitory machine readable storage medium of claim 13, wherein the instructions cause the programmable circuitry to transpose the gate-level netlist into a hypergraph to identify the node.

15. The non-transitory machine readable storage medium of claim 14, wherein the instructions cause the programmable circuitry to:
identify a plurality of nodes in the hypergraph; and
learn embeddings for the plurality of nodes identified.

16. The non-transitory machine readable storage medium of claim 15, wherein the instructions cause the programmable circuitry to cluster the learned embeddings.

17. The non-transitory machine readable storage medium of claim 16, wherein the instructions cause the programmable circuitry to convert the clustered learned embeddings to soft placement guides, the soft placement guides to be used to update the cell placement arrangement.

18. The non-transitory machine readable storage medium of claim 13, wherein, to learn the embedding, the instructions cause the programmable circuitry to identify an existing embedding for the node.

19. The non-transitory machine readable storage medium of claim 18, wherein the node is a first node and the neighboring node is a second node, wherein the instructions cause the programmable circuitry to aggregate a neighboring embedding from the second node, the aggregated neighboring embedding including features of the second node corresponding to an operation of the second node, the neighboring embedding to be stored in a weight matrix.

20. (canceled)

21. A method comprising:
extracting a gate-level netlist from a cell placement arrangement, the cell placement arrangement corresponding to cells on a semiconductor die;
identifying information from the gate-level netlist corresponding to an operation of the gate-level netlist;
learning, using unsupervised learning, an embedding for a node in the gate-level netlist; and
updating the cell placement arrangement based on the learned embedding of the node.

22-40. (canceled)
